(19) United States
(12) Patent Application Publication
(10) Pub. No.: US 2026/0225488 A1
(43) Pub. Date: Aug. 6, 2026

(54) ELECTRIC VEHICLE CHARGE MANAGEMENT SYSTEM

(71) Applicant: FCA US LLC, Auburn Hills, MI (US)

(72) Inventors: Katherine K Morrow-Abraham, Auburn Hills, MI (US); Samuel Phelps, Auburn Hills, MI (US); Alexandra Krisztian, Auburn Hills, MI (US); Michael Burke, Auburn Hills, MI (US)

(21) Appl. No.: 19/042,159

(22) Filed: Jan. 31, 2025

(51) Int. Cl. B60L 53/64; B60L 53/66; G06Q 30/0283; G06Q 50/06

(52) U.S. Cl. CPC B60L 53/64; B60L 53/665; G06Q 30/0283; G06Q 50/06; B60L 2250/16

(57) ABSTRACT

An electrified vehicle (EV) charge management system for charging of one or more electrified vehicles having a high voltage (HV) battery system includes a human machine interface (HMI) configured to display information to a user, and a controller configured for signal communication with the HMI, electric vehicle supply equipment (EVSE), and a battery management system (BMS). The controller is configured to determine an electricity rate at the EVSE, wherein the electricity rate includes a standard rate, an off-peak rate, and/or an on-peak rate, determine a charging session cost based on the determined electricity rate and information from the BMS indicating how much the HV battery system will be charged, generate an EV energy report that includes the determined charging session cost, and send the generated EV energy report to a user of the electrified vehicle.

### FIELD

The present application relates generally to electrified vehicles and, more particularly, to systems and methods to coordinate and manage electrified vehicle charging.

### BACKGROUND

Electrified vehicles (EVs) include at least one electric traction motor powered by a high voltage battery system, which is capable of storing a finite amount of energy. Some electrified vehicles, such as battery electric vehicles (BEVs) and plug-in hybrid electric vehicles (PHEVs), are capable of charging their high voltage battery system using private charging stations or public roadside charging stations. However, users are often unable to obtain a clear picture of the long-term costs associated with electric vehicle charging at various locations and at various times of the day. While conventional charging systems work well for their intended purpose, it is desirable to provide continuous improvement in the relevant art.

### SUMMARY

In accordance with one example aspect of the invention, an electrified vehicle (EV) charge management system for charging of one or more electrified vehicles having a high voltage (HV) battery system is provided. In one example implementation, the EV charge management system includes a human machine interface (HMI) configured to display information to a user, and a controller configured for signal communication with the HMI, electric vehicle supply equipment (EVSE), and a battery management system (BMS). The controller includes one or more processors and a non-transitory computer-readable storage medium having a plurality of instructions stored thereon, which, when executed by the one or more processors, cause the one or more processors to perform operations comprising: determine an electricity rate at the EVSE, wherein the electricity rate includes a standard rate, an off-peak rate, and/or an on-peak rate; determine a charging session cost based on the determined electricity rate and information from the BMS indicating how much the HV battery system will be charged; generate an EV energy report that includes the determined charging session cost; and send the generated EV energy report to a user of the electrified vehicle.

In addition to the foregoing, the described EV charge management system may include one or more of the following features: wherein the controller is further configured to determine a cost difference between the charging session cost at the on-peak rate and the off-peak rate, wherein the generated EV energy report includes actual or potential cost savings for performing the charging session during the off-peak rate; wherein if the charging session is performed during the on-peak rate, the controller is further configured to suggest, via the HMI or the EV energy report, one or more times and locations to charge the electrified vehicle at the off-peak rate, to thereby reduce charging session cost for the electrified vehicle.

In addition to the foregoing, the described EV charge management system may include one or more of the following features: wherein the controller is further configured to suggest, via the HMI or the EV energy report, one or more times and locations to discharge the electrified vehicle to an electrical grid during the on-peak rate, to thereby increase cost savings for the electrified vehicle; and wherein the controller is further configured to determine an on-peak charging session cost based on the determined on-peak electricity rate and information from the BMS indicating how much the HV battery system will be charged; determine an off-peak charging session cost based on the determined off-peak electricity rate and information from the BMS indicating how much the HV battery system will be charged; determine a potential cost savings for charging the electrified vehicle with the off-peak electricity rate as opposed to the on-peak electricity rate; and display to the user, via the HMI, the potential cost savings prior to initiation of the charging session such that the user may make an informed decision whether to initiate the charging session.

In addition to the foregoing, the described EV charge management system may include one or more of the following features: wherein the controller determines the electricity rate at the EVSE based on information received from an electrical utility network; wherein the controller determines the electricity rate at the EVSE based on information received from a charging station network; wherein the controller determines the electricity rate at the EVSE based on a GPS location of the electrified vehicle; wherein the EV energy report includes all charging sessions for a predetermined period of time; and wherein the EV energy report is generated and sent weekly and/or monthly.

In accordance with another example aspect of the invention, a method is provided of operating an electrified vehicle (EV) charge management system for charging of one or more electrified vehicles having a high voltage (HV) battery system, a battery management system (BMS), and a human machine interface (HMI). In one example implementation, the method includes determining, by a controller having one or more processors, an electricity rate at an electric vehicle supply equipment (EVSE), wherein the electricity rate includes a standard rate, an off-peak rate, and/or an on-peak rate; determining, by the controller, a charging session cost based on the determined electricity rate and information from the BMS indicating how much the HV battery system will be charged; generating, by the controller, an EV energy report that includes the determined charging session cost; and sending, by the controller, the generated EV energy report to a user of the electrified vehicle.

In addition to the foregoing, the described method may include one or more of the following features: determining, by the controller, a cost difference between the charging session cost at the on-peak rate and the off-peak rate, wherein the generated EV energy report includes actual or potential cost savings for performing the charging session during the off-peak rate; wherein if the charging session is performed during the on-peak rate, the method further includes suggesting, via the HMI or the EV energy report, one or more times and locations to charge the electrified vehicle at the off-peak rate, to thereby reduce charging session cost for the electrified vehicle; and suggesting, via the HMI or the EV energy report, one or more times and locations to discharge the electrified vehicle to an electrical grid during the on-peak rate, to thereby increase cost savings for the electrified vehicle.

In addition to the foregoing, the described method may include one or more of the following features: determining, by the controller, an on-peak charging session cost based on the determined on-peak electricity rate and information from the BMS indicating how much the HV battery system will be charged; determining, by the controller, an off-peak charging session cost based on the determined off-peak electricity rate and information from the BMS indicating how much the HV battery system will be charged; determining, by the controller, a potential cost savings for charging the electrified vehicle with the off-peak electricity rate as opposed to the on-peak electricity rate; and displaying to the user, by the controller and via the HMI, the potential cost savings prior to initiation of the charging session such that the user may make an informed decision whether to initiate the charging session.

In addition to the foregoing, the described method may include one or more of the following features: wherein the controller determines the electricity rate at the EVSE based on information received from an electrical utility network; wherein the controller determines the electricity rate at the EVSE based on information received from a charging station network; wherein the controller determines the electricity rate at the EVSE based on a GPS location of the electrified vehicle; wherein the EV energy report includes all charging sessions for a predetermined period of time; and wherein the EV energy report is generated and sent weekly and/or monthly.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an electrified vehicle having an example EV charge management system in accordance with the principles of the present application;

FIG. 2 is an example schematic diagram of the EV charge management system in accordance with the principles of the present application; and

FIG. 3 is a flow diagram of an example EV charge management method using the system of FIG. 2, in accordance with the principles of the present application.

### DESCRIPTION

As previously described, electrified vehicle (EV) owners may find it difficult to understand and track the long-term costs associated with EV charging at various charging locations and at various times of the day, particularly due to energy supplier pricing. For example, many energy suppliers have different electricity rates (e.g., peak and off-peak) depending on time of day. However, these rates and associated times may change without notice to the EV owner.

Accordingly, described herein are systems and methods for EV charging management. The EV charge management system is configured to communicate with customer vehicles, energy supplier pricing data, and charging station networks to efficiently coordinate and track charging services. Further, the system is configured to provide user information (e.g., a user report) to clearly illustrate the costs associated with charging their EV, compare that cost with on/off-peak pricing to determine potential savings, and recommend charge times with the lowest cost and grid usage.

In one example, the EV charge management system monitors the times, days, charging power (kW), GPS location during EV charging sessions, and settings associated with the vehicle-to-grid connection. The system may also monitor scheduled charging events, including day, time, percentage of battery state of charge (SOC), as well as electricity rates for the applicable times and locations, and customer trends on energy usage. The system then utilizes the monitored information and generates a periodic report (e.g., weekly, monthly, annually) on costs saved from charging during off-peak hours, and potential savings from charging during off-peak hours or changing current schedules to off-peak hours. The system may also (i) suggest when to schedule charging times based on off-peak hours to reduce costs, (ii) suggest when to optimize Vehicle-to-Grid discharge during peak hours, and (iii) recommend new charging times, based on the customer's energy time usage, such that less energy is consumed by the home/consumer to thereby stabilize grid usage.

The “report” may be generated on the vehicle radio/infotainment unit (or other display) or on a computer application (e.g., on a portable electronic device) to provide the consumer with the option to automatically change the scheduled charge times to the recommended charge times. In the scenario where a customer has multiple regular charging locations where they are responsible for the electricity bill, the GPS location may be utilized to determine which location and electricity rate is being applied and adjust the report and recommended schedules, as necessary.

In general, the EV customer sets their own scheduled times to charge. However, the customer may be unaware of changes in electricity rates or they may forget to change scheduled charging times when a rate change takes place. As such, the EV charge management system monitors charging times, locations, and rates and provides the customer with charging analyses and suggested charging behaviors to reduce charging costs. The system may automatically detect and recommend changes to the charging schedule to optimize EV charging. In one example, this EV energy/charge report is tailored to each specific EV, utilizing their individual energy pricing, energy usage, and vehicle feature settings to determine the costs, saving, and optimal charge times given their unique situation.

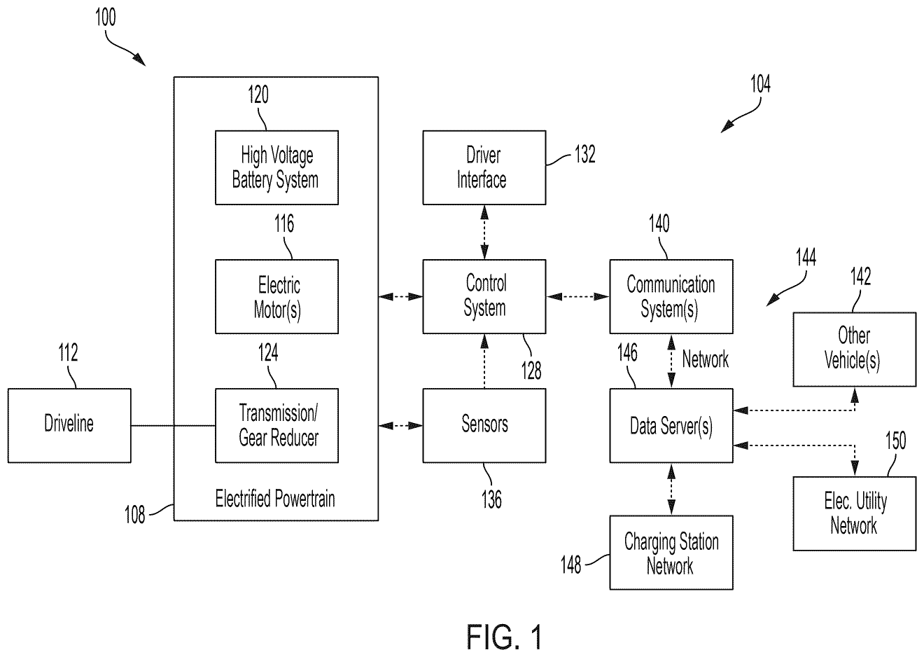

Referring now to FIG. 1, a functional block diagram of an electrified vehicle 100 configured to operate/interface with an example EV charge management system 104 according to the principles of the present application is illustrated. The electrified vehicle 100 includes an electrified powertrain 108 configured to generate and transfer torque to a driveline 112 for propulsion. The electrified powertrain 108 includes at least one electric motor 116 (e.g., a three-phase electric traction motor) powered by a high voltage battery pack or system 120. The electrified powertrain 108 also includes a transmission or gear reducer 124 configured to transfer the drive torque from the electric motor(s) 116 to the driveline 112. While an electric-only configuration of the electrified vehicle 100 (a battery electric vehicle, or BEV) is illustrated, it will be appreciated that the electrified powertrain 108 could further include another energy generator, such as an internal combustion engine (a hybrid electric vehicle, or HEV) and/or a hydrogen or other suitable fuel cell system (a fuel cell electric vehicle, or FCEV).

A control system 128 controls operation of the electrified vehicle 100, which primarily includes controlling the electrified powertrain 108 to generate a desired amount of drive torque to satisfy a driver torque request provided via a driver interface 132 (e.g., an accelerator pedal). A plurality of sensors 136 are configured to measure operating parameters of the electrified vehicle 100, such as, but not limited to, speeds/accelerations, pressures, temperatures, and electrical parameters (voltage, current, state of charge, etc.). The sensors 136 also include other vehicle systems, such as a navigation/maps system.

The control system 128 is also configured to communicate with other devices/systems using one or more communication systems 140 each configured for communication via a particular communication network or medium 144. For example, the communication systems 140 could include a long-range cellular communication transceiver, a short-range wireless communication (e.g., Bluetooth) transceiver. The network 144 can be any suitable communication network including, for example, a satellite network, a cellular network (3G, 4G LTE, 5G, etc.), a computing network (local area network, the internet, etc.), or some combination thereof.

One particular communication by the control system 128 via the communication system(s) 140 is with a set of one or more data servers 146 that store/analyze data provided by vehicle 100 or even another vehicle 142. The data servers 146 are in communication with a charging station network 148 that includes one or more individual charging stations (not shown), for example, to obtain available charging power options and associated EV charging rates. The data servers 146 may also be in communication with an electric utility network 150, for example, to obtain information relevant to EV charging for a particular location, such as electricity rates and on/off peak hours/rates. The data servers 146 may be owned and operated by a particular vehicle original equipment manufacturer (OEM) or other entity and may only be accessible to authorized users, such as through a computer application.

In some implementations, the EV charge management and reports generated therefrom are performed by the data servers 146, which may be a cloud-based system. The charge management system algorithm(s) may be run on the cloud-based system where they will have direct access to vehicle data and user charging schedules. The cloud-based data servers 146 can have substantial computing resources for execution of the algorithm(s). However, it will be appreciated that computing may alternatively be performed on-vehicle with control system 128 and communication system 140 may directly communicate with charging station network 148 and electric utility network 150.

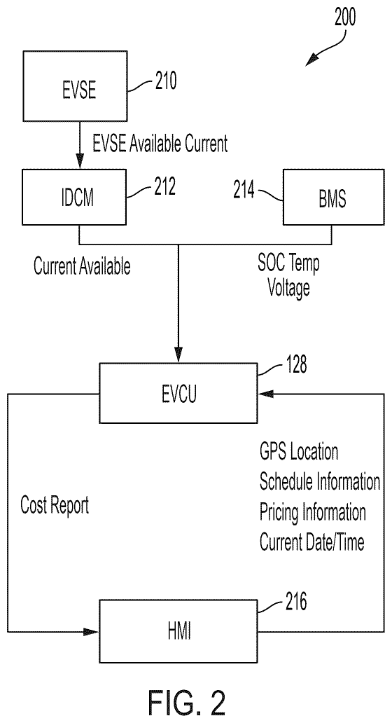

Referring now to FIG. 2, an example architecture 200 of the EV charge management system 104 is illustrated according to the principles of the present application. As shown, the EV charge management system 104 includes the supervisory controller 128, which is in signal communication with and is configured to coordinate interaction between powertrain modules, sensors, and other electrical and electronic modules or components. In the example embodiment, the supervisory controller 128 is configured for signal communication with electric vehicle supply equipment (EVSE) 210 via an integrated dual charging module (IDCM) 212, a battery management system (BMS) 214, and vehicle human machine interface (HMI) 216.

In the example embodiment, the EVSE 210 is a charging station such as a public charging station or a private home/work charging station. The EVSE 210 is an AC and/or DC charging unit configured to convert wall/grid power into usable energy for charging the vehicle 100. The IDCM 212 includes a DC/DC converter that converts high voltage from the HV battery system 120 to power lower voltage electrical loads and charge a low voltage battery (not shown), and an on-board charging module that converts AC power from the wall to DC to charge the battery system 120 when the vehicle is plugged in. In this way, the IDCM 212 is configured to support charging of the HV battery 120 from the EVSE 210 and also support low voltage (e.g., 12V) battery SOC maintenance.

The BMS 214 is configured to manage physical and electrical components of the HV battery 120. The BMS 214 is configured to provide input signals indicating state of charge (SOC), power consumption, and battery energy of the HV battery 120. The HMI 216 is a user interface such as the instrument cluster, radio, or other visual/touch interfaces. The HMI 216 is configured to receive input signals from supervisory controller 128, for example, indicating an SOC display, charging cost, scheduled charging, etc. The HMI 216 is also configured to display the EV energy/charge report and associated information, as described herein in more detail.

In one example operation, a user plugs the vehicle 100 in for charging of the HV battery 120. The EVSE 210 provides one or more signals to the IDCM 212 indicative of the available charge current/power, which is then sent to the controller 128. The BMS 214 sends one or more signals to the controller 128 indicating status information of the HV battery 120 (e.g., SOC, HV battery temperature, voltage, etc.).

Additionally, the HMI 216 sends one or more signals to the controller 128 indicative of information about the current charging session. For example, the HMI 216 may send a GPS location, scheduled charge information/settings, vehicle-to-grid functionality/settings, electricity pricing information, and current date/time. The GPS location may be determined by a GPS/Navigation System (not shown). The schedule information may provide various settings/data about scheduled charging. The electricity pricing information for the current charging session may be provided by the EVSE 210, other vehicles 142, the charging station network 148, the electric utility network 150, etc. or based on the GPS location. The current date/time may be utilized to determine the current electricity rate, track charging behavior (e.g., for scheduling), determine on/off peak pricing, etc.

Based on the received information, the controller 128 is configured to generate a report about the charging session. In one example, the controller 128 is configured to display the report on the HMI 216 for the user. The controller 128 may also save the report to memory for later use such as, for example, to generate a larger time-period report (e.g., weekly, monthly, etc.). Controller 128 may also send the generated report to a user's portable electronic device (e.g., via a computer app), or to the data server(s) 146 for future use and/or further distribution (e.g., email the report to a user's email address). As previously described, the report may include information about one or more charging sessions (e.g., time, cost, rate, etc.), customer trends on energy usage, as well as suggested locations/times to charge the vehicle (e.g., during off-peak hours) or discharge the vehicle to the electrical grid (e.g., during peak hours).

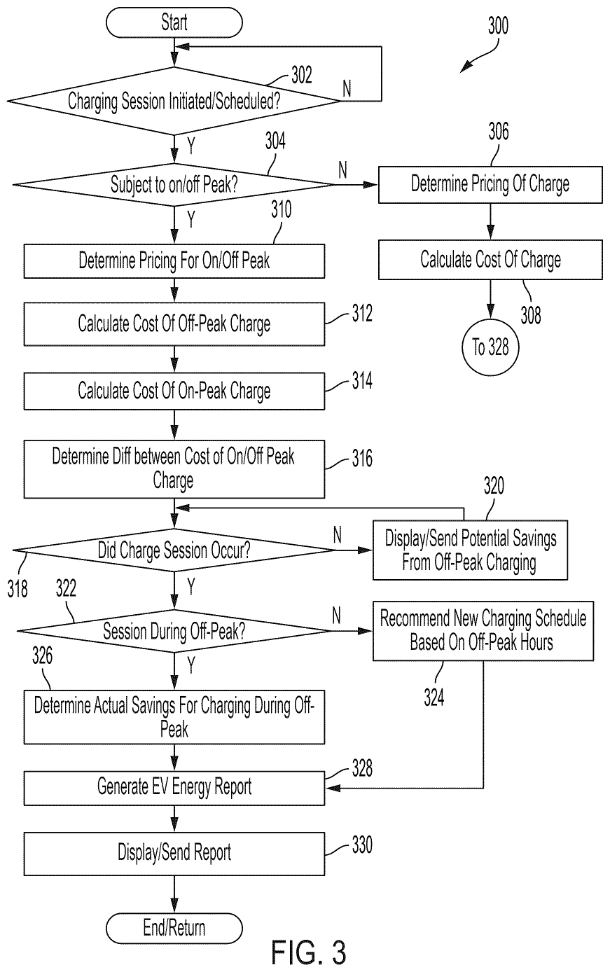

Referring now to FIG. 3, a flow diagram of an example method 300 of operating the EV charge management system 104 according to the principles of the present application is illustrated. While the method 300 specifically references the electrified vehicle 100 and its components for illustrative/descriptive purposes, it will be appreciated that the method 300 could be applicable to any suitably configured electrified vehicle.

In the example embodiment, the method begins at 302 and supervisory controller 128 (“control”) determines if a vehicle charging session is initiated or scheduled with an EVSE 210. If no, control ends or returns to 302. If yes, at 304, control determines if the EV charging location is subject to peak energy pricing. For example, this may be for the current location of vehicle 100, scheduled future charging sessions for vehicle 100, common charging locations for vehicle 100, etc. The existence of peak energy pricing may be determined, for example, by the vehicle HMI 216, other vehicles 142, data server(s) 146, charging station network 148, electric utility network 150, or by other suitable means. If no, control proceeds to 306. If yes, control proceeds to 310.

At 306, if peak pricing is not in force, control determines the pricing of the charge at that particular location. For example, control determines the rate of charging for the particular session (e.g., $/kWh). At 308, control determines the total cost of the charging session. For example, control determines the amount of charge power to be received during the charging session multiplied by the determined rate (306). Control then proceeds to 328.

At 310, if peak pricing is in force, control determines both the on-peak and off-peak pricing of the charge at that particular time/location. For example, control determines the rate of charging for the particular session (e.g., $/kWh). The on/off peak energy pricing may be determined, for example, by the vehicle HMI 216, other vehicles 142, data server(s) 146, charging station network 148, electric utility network 150, or by other suitable means. At 312, control determines the total cost of the off-peak charging session. At 314, control determines the total cost of the on-peak charging session. At 316, control determines the cost difference between the cost of the off-peak and on-peak charging sessions.

At 318, control determines if the charging session already occurred or is in progress. If no, at 320, control displays (e.g., on HMI 216) and/or sends (e.g., to a user portable electronic device) a notification of the potential savings from off-peak charging (as determined at 316). Control then returns to 318. However, if the charging session already occurred or is in progress, control proceeds to 322.

At 322, once the charging session is completed, control determines if the charging session occurred during off-peak hours. If no, control proceeds to 324. If yes, control proceeds to 326. At 324, control provides a notification to the user (e.g., via HMI 216, portable electronic device, etc.) recommending that future charging sessions be performed during off-peak hours. Control may suggest one or more particular charging schedules in order to meet the recommendation. Control then proceeds to 328.

At 326, control determines an actual cost savings (e.g., in a currency) for charging during the off-peak hours as opposed to charging during on-peak hours. Control then proceeds to 328 and generates an EV energy report based on one or more of the previous charging sessions. For example, the EV energy report may include cost information from a standard rate charge (308), an off-peak rate charge (312), and/or an on-peak rate charge (314). The report may also include suggested days/times/locations to reduce the cost of EV charging sessions. At 330, control displays the EV energy report to the user (e.g., via HMI 216) and/or sends the EV energy report to the user (e.g., via electronic portable device). Control then ends or returns to 302.

It will be appreciated that the term “controller” or “module” or “computing server/device” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems, and/or functions between various examples may be expressly contemplated herein so that one skilled in the art will appreciate from the present teachings that features, elements, systems, and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electrified vehicle (EV) charge management system for charging an electrified vehicle having a high voltage (HV) battery system, the EV charge management system comprising:
a human machine interface (HMI) configured to display information to a user; and
a controller configured for signal communication with the HMI, electric vehicle supply equipment (EVSE), and a battery management system (BMS), the controller having one or more processors and a non-transitory computer-readable storage medium having a plurality of instructions stored thereon, which, when executed by the one or more processors, cause the one or more processors to perform operations comprising:
determine an electricity rate at the EVSE, wherein the electricity rate includes a standard rate, an off-peak rate, and/or an on-peak rate;
determine a charging session cost based on the determined electricity rate and information from the BMS indicating how much the HV battery system will be charged;
generate an EV energy report that includes the determined charging session cost; and
send the generated EV energy report to a user of the electrified vehicle.

2. The EV charge management system of claim 1, wherein the controller is further configured to:
determine a cost difference between the charging session cost at the on-peak rate and the off-peak rate,
wherein the generated EV energy report includes actual or potential cost savings for performing the charging session during the off-peak rate.

3. The EV charge management system of claim 1, wherein if the charging session is performed during the on-peak rate, the controller is further configured to:
suggest, via the HMI or the EV energy report, one or more times and locations to charge the electrified vehicle at the off-peak rate, to thereby reduce charging session cost for the electrified vehicle.

4. The EV charge management system of claim 3, wherein the controller is further configured to:
suggest, via the HMI or the EV energy report, one or more times and locations to discharge the electrified vehicle to an electrical grid during the on-peak rate, to thereby increase cost savings for the electrified vehicle.

5. The EV charge management system of claim 1, wherein the controller is further configured to:
determine an on-peak charging session cost based on the determined on-peak electricity rate and information from the BMS indicating how much the HV battery system will be charged;
determine an off-peak charging session cost based on the determined off-peak electricity rate and information from the BMS indicating how much the HV battery system will be charged;
determine a potential cost savings for charging the electrified vehicle with the off-peak electricity rate as opposed to the on-peak electricity rate; and
display to the user, via the HMI, the potential cost savings prior to initiation of the charging session such that the user may make an informed decision whether to initiate the charging session.

6. The EV charge management system of claim 1, wherein the controller determines the electricity rate at the EVSE based on information received from an electrical utility network.

7. The EV charge management system of claim 1, wherein the controller determines the electricity rate at the EVSE based on information received from a charging station network.

8. The EV charge management system of claim 1, wherein the controller determines the electricity rate at the EVSE based on a GPS location of the electrified vehicle.

9. The EV charge management system of claim 1, wherein the EV energy report includes all charging sessions for a predetermined period of time.

10. The EV charge management system of claim 1, wherein the EV energy report is generated and sent weekly and/or monthly.

11. A method of operating an electrified vehicle (EV) charge management system for charging an electrified vehicle having a high voltage (HV) battery system, a battery management system (BMS), and a human machine interface (HMI), the method comprising:
determining, by a controller having one or more processors, an electricity rate at an electric vehicle supply equipment (EVSE), wherein the electricity rate includes a standard rate, an off-peak rate, and/or an on-peak rate;
determining, by the controller, a charging session cost based on the determined electricity rate and information from the BMS indicating how much the HV battery system will be charged;
generating, by the controller, an EV energy report that includes the determined charging session cost; and
sending, by the controller, the generated EV energy report to a user of the electrified vehicle.

12. The method of claim 11, further comprising:
determining, by the controller, a cost difference between the charging session cost at the on-peak rate and the off-peak rate,
wherein the generated EV energy report includes actual or potential cost savings for performing the charging session during the off-peak rate.

13. The method of claim 11, wherein if the charging session is performed during the on-peak rate, the method further comprises:
suggesting, via the HMI or the EV energy report, one or more times and locations to charge the electrified vehicle at the off-peak rate, to thereby reduce charging session cost for the electrified vehicle.

14. The method of claim 13, further comprising:
suggesting, via the HMI or the EV energy report, one or more times and locations to discharge the electrified vehicle to an electrical grid during the on-peak rate, to thereby increase cost savings for the electrified vehicle.

15. The method of claim 11, further comprising:
determining, by the controller, an on-peak charging session cost based on the determined on-peak electricity rate and information from the BMS indicating how much the HV battery system will be charged;
determining, by the controller, an off-peak charging session cost based on the determined off-peak electricity rate and information from the BMS indicating how much the HV battery system will be charged;
determining, by the controller, a potential cost savings for charging the electrified vehicle with the off-peak electricity rate as opposed to the on-peak electricity rate; and
displaying to the user, by the controller and via the HMI, the potential cost savings prior to initiation of the charging session such that the user may make an informed decision whether to initiate the charging session.

16. The method of claim 11, wherein the controller determines the electricity rate at the EVSE based on information received from an electrical utility network.

17. The method of claim 11, wherein the controller determines the electricity rate at the EVSE based on information received from a charging station network.

18. The method of claim 11, wherein the controller determines the electricity rate at the EVSE based on a GPS location of the electrified vehicle.

19. The method of claim 11, wherein the EV energy report includes all charging sessions for a predetermined period of time.

20. The method of claim 11, wherein the EV energy report is generated and sent weekly and/or monthly.
